(19) United States
(12) Patent Application Publication
(10) Pub. No.: US 2002/0014178 A1
(43) Pub. Date: Feb. 7, 2002

(54) Biocide compositions and methods and systems employing same

(76) Inventors: John Christian Haught, West Chester, OH (US); Gregory Scot Miracle, Hamilton, OH (US); Andre Christian Convents, Cincinnati, OH (US)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(21) Appl. No.: 09/903,309

(22) Filed: Jul. 11, 2001

Related U.S. Application Data
(60) Provisional application No. 60/218,207, filed on Jul. 14, 2000.

(51) Int. Cl. C09D 5/14

(52) U.S. Cl. 106/15.05

(57) ABSTRACT

The present invention relates to biocides, more particularly salicylanilide compositions, preferably substituted salicylanilide compositions, useful in biocide compositions, bacteria-reducing systems, biocide products and bacteria-reducing methods.

### CROSS REFERENCE

This application claims benefit under 119(e) of U.S. Serial No. 60/218,207, filed Jul. 14, 2000.

### FIELD OF THE INVENTION

The present invention relates to biocide methods and systems, more particularly biocide methods and systems utilizing a salicylanilide substituted compositions, preferably monosubstituted salicylanilide compositions, most preferably monohalogenated salicylanilide compositions.

### BACKGROUND OF THE INVENTION

Biocide compositions have become extremely important in today's society. Biocide compositions are useful in controlling or inhibiting the growth of microorganisms, such as bacteria.

Biocide compositions are conventionally used as agricultural pesticides, marine antifouling agents, as well as numerous other systems that require the control or inhibition of growth of microorganisms, such as fungi, bacteria and algae.

There is a continuing need to identify and develop improved biocide compositions for use in various methods and/or systems to control and/or inhibit the growth of microorganisms such as bacteria.

### SUMMARY OF THE INVENTION

The present invention meets and fulfills the needs identified above by providing biocide compositions, methods and systems that employ certain biocides, preferably substituted salicylanilide compounds.

Surprisingly, it has been found that certain classes of salicylanilide compounds, which were originally identified as having little or no antibacterial properties, exhibit antibacterial properties in certain formulations.

In one aspect of the present invention, a biocide composition comprising a biocide, preferably a substituted salicylanilide compound of formula I:

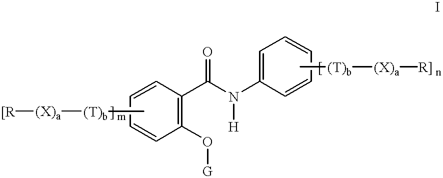

wherein m is an integer from 0 to 2; n is an integer from 0 to 2; the sum of m+n is greater than zero; a is 0 or 1; b is 0 or 1; X, when present, is selected from 0, S, and NR¹, where R¹ is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl; T, when present, is selected from C═O and SO₂; when T is SO₂, X may not be S; R is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl provided that the ratio of halogen atoms to the carbon atoms in said R is less than 3; when a and b are both 0 for a radical, R for that radical may be further selected from the group consisting of F, Cl, Br, I, CN, R₂N→O, NO₂; when all a and b are 0, at least one R must be non-H; no more than one R may be halogen; G is H, a suitable charge balancing counterion (Mⁿ⁺)_{1/n}, or a cleaveable group selected from the group consisting of Si((O)ₚR²)₃, where p is independently 0 or 1; C(O)_{q}((O)ₚR²)ᵣ, wherein p is independently 0 or 1 and when q is 1, r is 1, and when q is 0, r is 3; R² is independently selected from the group consisting of C₁-C₁₆ linear or branched, substituted or unsubstituted alkyl, alkenyl, alkynyl, cycloalkyl, cycloalkenyl, alkaryl, aralkyl, and aryl, and mixtures thereof is provided.

The biocide composition of the present invention may optionally, but preferably comprise one or more carriers preferably selected from the group consisting of surfactant systems, solvent systems and mixtures thereof, more preferably one or more of the following additional components:

1) at least 1 wt %, more preferably 5wt %, of a surfactant system, wherein the ratio of the weight of the surfactant system divided by the weight of the compound I is greater than or equal to 1.0; and

2) from 0.5% to 90% of a solvent, solvent system, or combinations thereof whose Hildebrand total solubility parameter (As reported in “Hansen Solubility Parameters A User's Handbook” by Charles Hansen, 1999, CRC Press; or as calculated by the commercial computer programs Cheops (MillionZillion Software, Inc.) or Synthia (Molecular Simulations, Inc.)) d_{S} (cal/cm³)^{½} meets the following criterion: 5<d_{S}<20; wherein a 10 wt % aqueous solution of this composition has a pH≧(pKa−1) where pKa is the calculated pKa (according to the computer program ACD/pKa DB by Advanced Chemistry Development, Inc.) at 25° C. and zero ionic strength of the phenol or thiophenol of formula I, or when G is not H, the pKa of the phenol or thiophenol of formula I that results from replacing G with H.

In yet another aspect of the present invention, a method for microorganism-reducing a microorganism-containing substrate comprising contacting the substrate with a microorganism-reducing system according to the present invention, is provided.

In still another aspect of the present invention, a microorganism-reduced substrate/article made by the method of present invention, is provided.

In still yet another aspect of the present invention, a microorganism-reducing product comprising a biocide composition and/or microorganism-reducing system of the present invention, is provided.

Accordingly, the present invention provides biocide compositions, microorganism-reducing systems, microorganism-reducing methods, microorganism-reducing products and microorganism-reduced substrates/articles made by the methods that employ a biocide, preferably a substituted salicylanilide.

These and other objects, features and advantages will be clear from the following detailed description, examples and appended claims.

All percentages, ratios and proportions herein are on a weight basis based on a neat product unless otherwise indicated. All documents cited herein are hereby incorporated by reference.

### DETAILED DESCRIPTION OF THE INVENTION

Definitions

“System”—“System” as used herein means a complex unity formed of many often, but not always, diverse parts (i.e., materials, compositions, devices, appliances, procedures, methods, conditions, etc.) subject to a common plan or serving a common purpose.

“Microorganism Reduced Substrate/Article”—“Microorganism Reduced Substrate/Article” as used herein means a substrate/article in which the microorganisms present on and/or in the substrate/article have been reduced.

“Effective Amount”—“Effective Amount” as used herein means an amount of a material that is sufficient to provide a desired benefit. For example, “an effective amount of a biocide” is an amount of the biocide that is sufficient to provide a desired benefit; namely, to control and/or inhibit the growth of microorganisms.

“Substituted”—“Substituted” as used herein means that the organic composition or radical to which the term is applied is:

(a) made unsaturated by the elimination of elements or radical; or

(b) at least one hydrogen in the compound or radical is replaced with a moiety containing one or more (i) carbon, (ii) oxygen, (iii) sulfur, (iv) nitrogen or (v) halogen atoms; or

(c) both (a) and (b).

(i) Moieties which may replace hydrogen as described in (b) immediately above, which contain only carbon and hydrogen atoms are all hydrocarbon moieties including, but not limited to, alkyl, alkenyl, alkynyl, alkyldienyl, cycloalkyl, phenyl, alkyl phenyl, naphthyl, anthryl, phenanthryl, fluoryl, steroid groups, and combinations of these groups with each other and with polyvalent hydrocarbon groups such as alkylen, alkylidene and alkylidyne groups. Specific nonlimiting examples of such groups are:

—CH₃,—CHCH₃CH₃,—(CH₂)₈CH₃, —CH₂—C≡CH, —CH═CH—CH═CH₂,

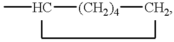

—ΦCH₃, —ΦCH₂Φ, —Φ, and —Φ—Φ.

(ii) Moieties containing oxygen atoms which may replace hydrogen as described in (b) immediately above include hydroxy, acyl or keto, ether, epoxy, carboxy, and ester containing groups. Specific nonlimiting examples of such oxygen containing groups are:

φ—CH₂OH, —CCH₃CH₃OH, —CH₂COOH, —C(O)—(CH₂)₈CH₃, —OCH₂CH₃, ═O, —OH, —CH₂—O—CH₂CH₃, —CH₂—O—(CH₂)₂—OH, —CH₂CH₂COOH, -ΦOOH, -ΦOCH₂CH₃, —ΦCH₂OH,

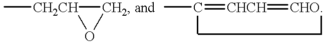

(iii) Moieties containing sulfur atoms which may replace hydrogen as described in (b) immediately above include the sulfur-containing acids and acid ester groups, thioether groups, mercapto groups and thioketo groups. Specific nonlimiting examples of such sulfur containing groups are:

φ—SCH₂CH₃, —CH₂S(CH₂)₄CH₃, —SO₃CH₂CH₃, SO₂CH₂CH₃, —CH₂COSH, —SH, —CH₂SCO, —CH₂C(S)CH₂CH₃, —SO₃H, —O(CH₂)₂C(S)CH₃, ═S, and

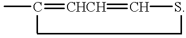

(iv) Moieties containing nitrogen atoms which may replace hydrogen as described in (b) immediately above include amino groups, the nitro group, azo groups, ammonium groups, arnide groups, azido groups, isocyanate groups, cyano groups and nitrile groups. Specific nonlimiting examples of such nitrogen containing groups are:

—NHCH₃, —NH₂, —NH₃⁺, —CH₂CONH₂, —CH₂CON₃, —CH₂CH₂CH═NOH, —CN, —CH(CH₃)CH₂NCO, —CH₂NCO, —NΦ, -ΦNΦOH, and ≡N.

(v) Moieties containing halogen atoms which may replace hydrogen as described in (b) immediately above include chloro, bromo, fluoro, iodo groups and any of the moieties previously described where a hydrogen or a pendant alkyl group is substituted by a halo group to form a stable substituted moiety. Specific nonlimiting examples of such halogen containing groups are:

—(CH₂)₃Cl, -ΦF₅, -ΦCl, —CF₃, and —CH₂ΦBr.

It is understood that any of the above moieties (i) through (v) can be substituted into each other in either a monovalent substitution or by loss of hydrogen in a polyvalent substitution to form another monovalent moiety which can replace hydrogen in the organic compound or radical. φ-“Φ” as used herein represents a phenyl ring.

Biocide

In a preferred embodiment of the present invention, the biocide comprises a salicylanilide compound having the formula I:

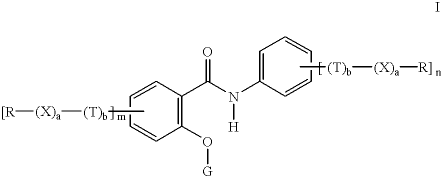

wherein m is an integer from 0 to 2; n is an integer from 0 to 2; the sum of m+n is greater than zero; a is 0 or 1; b is 0 or 1; X, when present, is selected from 0, S, and NR¹, where R¹ is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl; T, when present, is selected from C═O and SO₂; when T is SO₂, X may not be S; R is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl provided that the ratio of halogen atoms to the carbon atoms in said R is less than 3; when a and b are both 0 for a radical, R for that radical may be further selected from the group consisting of F, Cl, Br, I, CN, R₂N→O, NO₂; when all a and b are 0, at least one R must be non-H; no more than one R may be halogen; G is H, a suitable charge balancing counterion (Mⁿ⁺)_{1/n}, or a cleaveable group selected from the group consisting of Si((O)ₚR²)₃, where p is independently 0 or 1; C(O)_{q}((O)ₚR²)ᵣ, wherein p is independently 0 or 1 and when q is 1, r is 1, and when q is 0, r is 3; R² is independently selected from the group consisting of C₁-C₁₆ linear or branched, substituted or unsubstituted alkyl, alkenyl, alkynyl, cycloalkyl, cycloalkenyl, alkaryl, aralkyl, and aryl, and mixtures thereof.

Specific non-limiting examples of substitutions that can be made on the salicylanilide rings include the following:

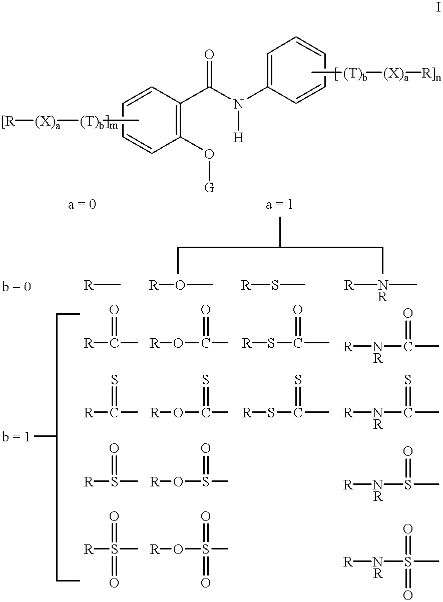

In preferred embodiments of the present invention, the biocides are selected from monosubstituted salicylanilides, including but not limited to, 5-chlorosalicylanilide, 4-chlorosalicylanilide, 5-iodosalicyanilide, 4-iodosalicylanilide, 5-fluorosalicylanilide, 4-fluorosalicylanilide, 5-cyanosalicylanilide, 4-cyanosalicylanilide, 5-acetylsalicylanilide, and 4-acetylsalicylanilide. The salts of the aforementioned compounds are also a preferred species.

In highly preferred embodiments of the present invention, the biocides are selected from monohalogenated salicylanilide compounds, preferably 4-halosalicylanilide and 5-halosalicylanilide, more preferably 4-chlorosalicylanilide and 5-chlorosalicylanilide, most preferably 5-chlorosalicylanilide.

Microorganism-reducing System

The biocide of the present invention is useful in reducing microorganisms on a substrate/article, when the biocide is incorporated into a microorganism-reducing system.

Preferably, such a microorganism-reducing system further comprises a suitable carrier, more preferably a surfactant system and/or a solvent system.

In a preferred embodiment of the present invention, a microorganism-reducing system comprising:

a) an effective amount, preferably from about 0.001%, more preferably from about 0.01%, even more preferably from about 0.05% to about 15%, more preferably to about 10%, even more preferably to about 5%, most preferably to about 2.5% by weight of the system of a biocide of the present invention; and

b) at least 1% by weight of the composition of a surfactant system;

wherein the weight ratio of the surfactant system to the biocide is greater than or equal to 1.0, is provided.

In another preferred embodiment of the present invention, a microorganism-reducing system comprising:

a) an effective amount, preferably from about 0.001%, more preferably from about 0.01%, even more preferably from about 0.05% to about 15%, more preferably to about 10%, even more preferably to about 5%, most preferably to about 2.5% by weight of the system of a biocide of the present invention; and

b) from about 0.5% to about 90% by weight of the composition of a solvent whose Hildebrand solubility parameter δₛ (cal/cm³)^{½} meets the following criterion: 5<δₛ<20;

wherein a 10 wt % aqueous solution of the composition has a pH≧(pKa−1) where pKa is the calculated pKa of the biocide where -Z-G is -Z-H, is provided.

In yet another embodiment of the present invention, a microorganism-reducing system comprising:

a) an effective amount, preferably from about 0.001%, more preferably from about 0.01%, even more preferably from about 0.05% to about 15%, more preferably to about 10%, even more preferably to about 5%, most preferably to about 2.5% by weight of the system of a biocide of the present invention;

b) at least 1% by weight of the composition of a surfactant system;

wherein the weight ratio of the surfactant system to the biocide is greater than or equal to 1.0; and

c) from about 0.5% to about 90% by weight of the composition of a solvent whose Hildebrand solubility parameter δₛ (cal/cm³)^{½} meets the following criterion: 5<δₛ<20;

wherein a 10 wt % aqueous solution of the composition has a pH≧(pKa−1) where pKa is the calculated pKa of the biocide where -Z-G is -Z-H, is provided.

The substrate may be a hard or soft substrate. Hard substrates are non-limitingly selected from the group consisting of: agricultural crops and/or plants, and mixtures thereof. Soft substrates are non-limitingly selected from the group consisting of: textiles, fabrics, garments, sponges, wash cloths, brushes, gloves, scouring pads, reusable wipes, animal and human skin (i.e., personal cleansing applications) and mixtures thereof. In addition to these substrates, the substrates may include food articles, such as fruits, meats and liquids, such as water.

The bacteria on and/or in the substrate can be selected from the group consisting of: Staphylococcus aureus, Staphylococcus haemolyticus, Staphylococcus capitis, Klebsiella pneumoniae, Proteus mirabilis, Serratia marcescens, Staphylococcus epidermis, Salmonella typhimurium, Shigella dysenteriae, Streptococcus faecalis, Streptococcus pyogenes, Corynebacterium xerosis, Micrococcus varians, Micrococcus luteus, Peptostreptococcus anaerobius, Propionibacterium acnes, Propionibacterium avidum, Propionibacterium granulosum, Escherichia coli, Salmonella choleraesius, Listeria monocytogenes, Enterococcus hirae and mixtures thereof, more preferably, Escherichia coli, Salmonella choleraesius, Listeria monocytogenes and mixtures thereof, and most preferably Escherichia coli, Salmonella choleraesius and mixtures thereof.

Biocide Composition

The biocide of the present invention is preferably incorporated with one or more additional adjunct ingredients into one or more biocide compositions. Preferably, the biocide compositions of the present invention are free of aminopolyureylene resin because unlike prior art biocide compositions the biocides and systems and compositions of the present invention exhibit relatively dilute efficacy and do not require a resin to attach the biocides to a substrate to be efficacious.

These one or more additional adjunct ingredients are determined according to the type of composition that the biocide is to be incorporated into and/or the type of use of the biocide composition.

The applicability of the biocides of the present invention for combating microorganisms, particularly bacteria, and for preserving organic materials and objects from infestation by microorganisms, is very extensive. Thus, for example, the biocides can be incorporated directly into the material to be preserved, e.g. into material having a synthetic resin base, such as polyamides and polyvinyl chloride, into paper-treatment liquors, into printing thickeners made from starch or cellulose derivatives, into lacquers and paints which contain, for example, casein, into cellulose, viscous spinning solutions, paper, into animal mucus or oils, into permanent coatings based on polyvinyl alcohol, cosmetic articles, and into ointments or powders. They can also be added to preparations of inorganic or organic pigments for the paint industry, to plasticisers, etc.

The biocides of the present invention can be used furthermore in the form of their organic solutions, e.g. as sprays, or as dry-cleaning agents, or for the impregnation of wood, suitable organic solvents being preferably solvents immiscible with water, particularly petroleum fractions, but also solvents miscible with water, such as lower alcohols, e.g. methanol or ethanol or ethylene glycol monomethyl ether, or -monoethyl ether.

The biocides of the present invention may also be used in the form of aqueous solutions.

Furthermore, they can be used together with wetting or dispersing agents, in the form of their aqueous dispersions, e.g. for the preservation of substances which tend to rot, for example for the preservation of leather, paper etc., since they undergo a slighter deactivation through wetting agents and dispersants.

The biocide can be incorporated into a range of different biocide compositions and/or products for controlling or inhibiting the growth of microorganisms, such as bacteria, in a locus. Suitable loci include, but are not limited to, cooling towers, air washers, air duct ventilation systems, mineral slurries, pulp and paper processing fluids, paper coatings, swimming pools, spas, adhesives, caulks, mastics, sealants, agriculture adjuvant preservation, construction products, leather and leather products, wood (including lumber, timber, fiberboard, plywood and wood composites), plastics, lubricants, hydraulic fluids, medical devices, metalworking fluids, emulsions and dispersions, paints (including marine paints), varnishes (including marine varnishes), latexes, odor control fluids, coatings (including marine coatings), petroleum processing fluids, fuel, oil field fluids, photographic chemicals, printing fluids, sanitizers, agricultural pesticides, food processing equipment (including slaughterhouse equipment, poultry processing equipment, fish and seafood processing equipment), textile mill fluids and equipment, unfinished and finished textiles and textile products, carpet treating compositions, upholstery treating compositions, flower and/or plant preservatives and/or protective compositions, soil treating compositions, seed treating compositions, water treatment equipment and/or compositions, dairy and bottling equipment, animal health equipment and/or compositions.

These biocide compositions and/or products may be in any form known to those skilled in the art. For example, the compositions and/or products may be in liquid, granular, powder, tablet, paste, foam, gel, dust and/or bar form. These biocide compositions and/or products may be neat or releasably absorbed or adsorbed on to a substrate, such as a woven or non-woven filament substrate.

In one preferred embodiment, the biocide compositions of the present invention are in a form such that a substrate/article can be sprayed with a spray dispensing device, hand-held or otherwise, preferably in liquid form. Such biocide compositions are particularly suitable for use as agriculture pesticides and/or flower and/or plant treating compositions.

In another preferred embodiment, the biocide compositions of the present invention are in a form such that a substrate/article can be dipped and/or soaked, preferably in liquid form.

In yet another preferred embodiment, the biocide compositions of the present invention are in a form such that a substrate/article can be coated with the biocide compositions, preferably in liquid, paste, foam and/or gel form.

In still another preferred embodiment, the biocide compositions of the present invention are in a form such that a substrate/article can be dusted and/or powdered with the biocide compositions, preferably in powder and/or granular form.

The biocides of the present invention can be used on a very broad basis, in particular for protecting organic substrates from attack by harmful and pathogenic microorganisms. The biocides are suitable accordingly as preservatives and disinfectants for industrial products of all kinds, as well as for deodorization.

As examples of industrial products which can be preserved with the compounds of the formula (I) according to the invention the following may be mentioned: adhesive substances, binding agents, paints, textile assistants and finishing agents, oil pastes and printing pastes and similar preparation based on organic and inorganic dyestuffs and pigments, also those which contain casein or other organic compounds as admixtures. Wall and ceiling paints, for example those which contain an albuminous color binder, are also protected from attack by pests by addition of the compounds according to the invention. Their use for protecting wood is also possible.

By way of example, a paint composition in accordance with the present invention will preferably contain, in addition to one or more biocides of the present invention, a resin, an organic solvent (such as xylene or methylisobutylketone), a pigment and various optional additives such as thickening agent(s), wetting agents, and the like, as is well-known in the art. The resin is preferably employed in an amount of between about 20% and about 80% based upon the weight of the paint or paint base.

In addition, the paint composition of the present invention optionally additionally contains optional additives which have a favorable influence on the viscosity, the wetting power and the dispersibility, as well as on the stability to freezing and electrolytes and on the forming properties. If a marine paint is being fabricated, the paint preferably contains a swelling agent to cause the paint to gradually “slough off” in its marine environment, thereby causing renewed biocidal efficacy of newly exposed biocide (i.e., the pyrithione salt plus the copper salt) at the surface of the paint in contact with the water medium of the marine environment. Swelling agents can be used singly or in combination. The total amount of optional additives is preferably no greater than 20% by weight, more preferably between about 1% and about 5% by weight, based upon the total weight of the paint composition.

In order to increase the stability to freezing and electrolytes there may be added to the paint composition various monomer 1,2-diols, for example glycol, propylene-glycol-(1,2), and butylene-glycol-(1,2) or polymers thereof, or ethoxylated compounds, for example reaction products of ethylene oxide with long-chain alkanols, amines, carboxylic acids, carboxylic acid amides, alkyd phenols, poly(propylene-glycol) or poly(butylene-glycol).

The minimum temperature of film formation (white point) of the paint composition may be reduced by adding solvents, such as ethylene-glycol, butyl-glycol, ethyl-glycol acetate, ethyl-diglycol acetate, butyl-diglycol acetate, benzene or alkylated aromatic hydrocarbons. As defoaming agents there are suitable for example poly(propylene-glycol) and polysiloxanes.

The paint composition of the present invention may be used as a paint for natural or synthetic materials, for example wood, paper, metals, textiles and plastics. It is particularly suitable as an outdoor paint, and is excellent for use as a marine paint.

The compounds according to the invention can also be used as preservatives in the pulp and paper industry, inter alia for preventing the known formation of mucilage caused by microorganisms in the apparatus used for manufacturing paper.

The compounds according to the invention are used with advantage for providing fibers and textiles with a preservative and disinfectant finish. They can be applied to natural and synthetic fibers on which they exert a lasting action against harmful (also pathogenic) microorganisms, for example fungi and bacteria. The compounds can be added before, simultaneously with, or after a treatment of these textiles with other substances, e.g. oil or printing pastes, flameproofing agents, fabric softeners, and other finishing agents. Textiles thus treated also have protection against perspiration odor caused by microorganisms.

The forms in which the active substances according to the invention are applied correspond to the usual formulations. The agents used for the finishing or for the protection of textiles should contain the active substances in a finely divided form. In particular, solutions, dispersions and emulsions of the active substances are therefore used. Aqueous dispersions can be obtained, for example, from pastes or concentrates, and can be applied as liquids or in the aerosol form.

The aqueous solutions or dispersions advantageously contain surface-active agents; for example, anionic compounds such as soaps and other carboxylates (e.g. alkali salts of higher fatty acids), derivatives of sulphur-oxyacids (e.g. sodium salt of dodecylbenzenesulphonic acid, water-soluble salts of sulphuric acid monoesters of higher molecular alcohols or of their polyglycol ethers, for example soluble salts of dodecyl alcohol sulphate or of dodecyl alcohol polyglycol ether sulphate), derivatives of phosphorusoxyacids (e.g. phosphates), derivatives with acid (electrophilic) nitrogen in the hydrophilic group (e.g. disulphine salts), cationic surface-active agents, such as amines and their salts (e.g. lauryldiethylenetriamine), onium compounds, amine oxides or nonionic surface active agents, e.g. polyhydroxy compounds, surface-active agents based on mono- or polysaccharide, higher molecular acetylene glycols, polyglycol ethers (e.g. polyglycol ethers of higher fatty alcohols, polyglycol ethers of higher molecular-alkylated phenols). In addition, the liquor can contain conventional adjuvants, for example water-soluble perborates, polyphosphates, carbonates, silicates, fluorescent brighteners, plasticisers, acid reacting salts, e.g. ammonium- or zincsilicofluoride, or certain organic acids, e.g. oxalic acid, also finishing agents, e.g. those based on synthetic resin or on starch.

The textile materials can be impregnated with the active substances, e.g. by means of hot or cold aqueous dyeing, bleaching, chroming or aftertreatment baths, whereby various textile-finishing processes are suitable, e.g. the padding or exhaustion process.

The biocides according to the present invention can be used on their own or together with other known antimicrobial textile-preserving agents.

Suitable textiles to be finished or preserved are both fibers of natural origin, such as cellulose-containing fibers, e.g. cotton, or polypeptide-containing fibers, e.g. wool or silk, and fiber materials of synthetic origin, such as those based on polyamide, polyacrylonitrile or polyester, as well as blends of these fibers.

In general the textile materials are adequately preserved against infestation by fungi and bacteria by a content of 0.01 to 5%, preferably 0.1 to 3%, of active substance, based on the weight of the textile materials.

Detergents and cleansing agents having excellent antibacterial or antimycotic action are obtained by combining the compounds according to the invention with interfacial-active substances, especially with active detergents.

The detergents and cleansing agents can be in any desired form, e.g. in liquid, pasty, solid, flake or granular form. The compounds according to the invention can be incorporated into anionic compounds, such as soaps and other carboxylates (e.g. alkali salts of higher fatty acids), derivatives of sulphur-oxyacids (e.g. sodium salt of dodecylbenzenesulphonic acid, water-soluble salts of sulphuric acid monoesters of higher-molecular alcohols or of their polyglycol ethers, for example soluble salts of dodecyl alcohol sulphate or of dodecyl alcohol polyglycol ether sulphate), derivatives of phosphorusoxyacids (e.g. phosphates), derivatives with acid (electrophilic) nitrogen in the hydrophilic group (e.g. disulphine salts), as well as into cationic surface-active agents, such as amines and their salts (e.g. lauryldiethylenetriamine), onium compounds, amine oxides or nonionic surface-active agents, such as polyhydroxy compounds, surface-active agents based on mono- or polysaccharide, higher-molecular acetylene glycols, polyglycol ethers (e.g. polyglycol ethers of higher fatty alcohols, polyglycol ethers of higher-molecular alkylated phenols), or into mixtures of different surfactants. The biocidal activity of the new biocide compounds is therewith completely retained. The active substance content of the detergents and cleansing agents, based on the weight of this agent, is generally from 0.01 to 5%, generally 0.1 to 3%. Aqueous preparations of such detergents and cleansing agents containing compounds according to the invention can be employed, for example, for the antimicrobial finishing of textile materials, since the active substance can be absorbed substantively on to the textile material. They are also suitable as antimicrobial cleansing agents in the food manufacturing and bottling industries, e.g. in breweries, dairies, cheese dairies and slaughterhouses.

Furthermore, the compounds according to the invention can also be used in cosmetic preparations, e.g. volatile oils, bath salts, brilliantines, ointments, face lotions, hair-dyeing preparations, hair oils, hair tonics, skin creams, skin oils. Eau-de-Cologne, perfumes, powders, rouge, depilatorics, sun-ray filter creams, dental hygiene products, etc., in consequence of which there is additionally imparted to these products in antimicrobial and deodorant action. In general, an active-substance content, based on the total weight of the product, of 0.01 to 5%, preferably of 0.1 to 3%, suffices.

For example, a biocide composition in accordance with the present invention preferably comprises a biocide of the present invention with a surfactant system, preferably at least 1% by weight of the composition of a surfactant system, and/or a solvent, preferably from about 0.5% to 90% by weight of the composition of a solvent whose Hildebrand solubility parameter δₛ (cal/cm³)^{½} meets the following criterion: 5<δₛ<20, and wherein a 10 wt % aqueous solution of the composition has a pH≧(pKa−1) where pKa is the calculated pKa of the biocide where -Z-G is -Z-H, and/or a perfume, preferably a perfume wherein the perfume has a C log P greater than or equal to 2.0, and/or an enzyme.

Optionally, but preferably, the composition comprises one or more additional detergent adjunct ingredients selected from the group consisting of: bleaching systems, enzymes, brighteners, builders, chelants, soil release polymers, dye transfer inhibiting agents.

In a preferred embodiment of the present invention, a biocide composition comprising:

a) an effective amount, preferably from about 0.001%, more preferably from about 0.01%, even more preferably from about 0.05% to about 15%, more preferably to about 10%, even more preferably to about 5%, most preferably to about 2.5% by weight of the system of a biocide of the present invention; and

b) at least 1% by weight of the composition of a surfactant system;

wherein the weight ratio of the surfactant system to the biocide is greater than or equal to 1.0, is provided.

In another preferred embodiment of the present invention, a biocide composition comprising:

a) an effective amount, preferably from about 0.001%, more preferably from about 0.01%, even more preferably from about 0.05% to about 15%, more preferably to about 10%, even more preferably to about 5%, most preferably to about 2.5% by weight of the system of a biocide of the present invention; and

b) from about 0.5% to about 90% by weight of the composition of a solvent whose Hildebrand solubility parameter δₛ (cal/cm³)^{½} meets the following criterion: 5<δₛ<20;

wherein a 10 wt % aqueous solution of the composition has a pH≧(pKa−1) where pKa is the calculated pKa of the biocide where -Z-G is -Z-H, is provided

In still another embodiment of the present invention, a biocide composition comprising:

a) an effective amount, preferably from about 0.001%, more preferably from about 0.01%, even more preferably from about 0.05% to about 15%, more preferably to about 10%, even more preferably to about 5%, most preferably to about 2.5% by weight of the system of a biocide of the present invention;

b) at least 1% by weight of the composition of a surfactant system;

wherein the weight ratio of the surfactant system to the biocide is greater than or equal to 1.0; and

c) from about 0.5% to about 90% by weight of the composition of a solvent whose Hildebrand solubility parameter δₛ (cal/cm³)^{½} meets the following criterion: 5<δₛ<20;

wherein a 10 wt % aqueous solution of the composition has a pH>(pKa−1) where pKa is the calculated pKa of the biocide where -Z-G is -Z-H, is provided. microorganism-reducing

Preferred Adjunct Ingredients

Surfactants—A wide range of surfactants can be used in the compositions of the present invention.

Surfactants included in the fully-formulated compositions afforded by the present invention comprise at least 0.01%, preferably at least about 0.1%, more preferably at least about 0.5%, even more preferably at least about 1%, most preferably at least about 3% to about 80%, more preferably to about 60%, most preferably to about 50% by weight of composition depending upon the particular surfactants used and the desired effects to be achieved.

The surfactant can be nonionic, anionic, amphoteric, amphophilic, zwitterionic, cationic, semi-polar nonionic, and mixtures thereof, nonlimiting examples of which are disclosed in U.S. Pat. Nos. 5,707,950 and 5,576,282. A typical listing of anionic, nonionic, amphoteric and zwitterionic classes, and species of these surfactants, is given in U.S. Pat. No. 3,664,961 issued to Norris on May 23, 1972. Preferred compositions comprise nonionic surfactants and/or mixtures of nonionic surfactants with other surfactants, especially anionic surfactants.

i. Nonionic Surfactant

Suitable nonionic surfactants are generally disclosed in U.S. Pat. No. 3,929,678, Laughlin et al., issued Dec. 30, 1975, and U.S. Pat. No. 4,285,841, Barrat et al, issued Aug. 25, 1981. Exemplary, non-limiting classes of useful nonionic surfactants include: C₈-C₁₈ alkyl ethoxylates (“AE”), with EO about 1-22, including the so-called narrow peaked alkyl ethoxylates and C₆-C₁₂ alkyl phenol alkoxylates (especially ethoxylates and mixed ethoxy/propoxy), alkyl dialkyl amine oxide, alkanoyl glucose amide, and mixtures thereof.

If nonionic surfactants are used, the compositions of the present invention will preferably contain from about 1% to about 80%, more preferably from about 1% to about 60%, most preferably from about 1 % to about 50% by weight of nonionic surfactant.

Preferred nonionic surfactants include, but are not limited to, the ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15. These surfactants are more fully described in U.S. Pat. No. 4,284,532, Leikhim et al, issued Aug. 18, 1981. Particularly preferred are ethoxylated alcohols having an average of from about 9 to abut 15 carbon atoms in the alcohol and an average degree of ethoxylation of from about 5 to about 15 moles of ethylene oxide per mole of alcohol.

Other nonionic surfactants for use herein include:

The polyethylene, polypropylene, and polybutylene oxide condensates of alkyl phenols. Commercially available nonionic surfactants of this type include Igepal® CO-630, marketed by the GAF Corporation; and Triton® X-45, X-114, X-100, and X-102, all marketed by the Rohm & Haas Company. These compounds are commonly referred to as alkyl phenol alkoxylates, (e.g., alkyl phenol ethoxylates).

The condensation products of aliphatic alcohols with from about 1 to about 25 moles of ethylene oxide. Examples of commercially available nonionic surfactants of this type include Tergitol® 15-S-9 (the condensation product of C₁₁-C₁₅ linear secondary alcohol with 9 moles ethylene oxide), Tergitol® 24-L-6 NMW (the condensation product of C₁₂-C₁₄ primary alcohol with 6 moles ethylene oxide with a narrow molecular weight distribution), both marketed by Union Carbide Corporation; Neodol® 45-9 (the condensation product of C₁₄-C₁₅ linear alcohol with 9 moles of ethylene oxide), Neodol® 23-9 (the condensation product Of C₁₂-C₁₃ linear alcohol with 9 moles of ethylene oxide) ; Neodol® 23-6.5 (the condensation product of C₁₂-C₁₃ linear alcohol with 6.5 moles of ethylene oxide), Neodol® 45-7 (the condensation product of C₁₄-C₁₅ linear alcohol with 7 moles of ethylene oxide), Neodol® 45-4 (the condensation product of C₁₄-C₁₅ linear alcohol with 4 moles of ethylene oxide), marketed by Shell Chemical Company, and Kyro® EOB (the condensation product of C₁₃-C₁₅ alcohol with 9 moles ethylene oxide), marketed by The Procter & Gamble Company. Other commercially available nonionic surfactants include Dobanol 91-8® marketed by Shell Chemical Co. and Genapol UD-080® marketed by Hoechst. This category of nonionic surfactant is referred to generally as “alkyl ethoxylates.”

The condensation products of ethylene oxide with a hydrophobic base formed by the condensation of propylene oxide with propylene glycol. Examples of compounds of this type include certain of the commercially-available Pluronic® surfactants, marketed by BASF.

The condensation products of ethylene oxide with the product resulting from the reaction of propylene oxide and ethylenediamine. Examples of this type of nonionic surfactant include certain of the commercially available Tetronic® compounds, marketed by BASF.

Semi-polar nonionic surfactants, especially water-soluble amine oxides. Preferably, these amine oxide surfactants include C₁₀-C₁₈ alkyl dimethyl amine oxides and C₈-C₁₂ alkoxy ethyl dihydroxy ethyl amine oxides.

Alkylpolysaccharides disclosed in U.S. Pat. No. 4,565,647, Llenado, issued Jan. 21, 1986, having a hydrophobic group containing from about 6 to about 30 carbon atoms, and alkylpolyglycosides disclosed in EP-B 070 077 EP-B -075 996 and EP-B 094 118.

Fatty acid amide surfactants having the formula:

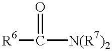

wherein R⁶ is an alkyl group containing from about 7 to about 21 (preferably from about 9 to about 17) carbon atoms and each R⁷ is selected from the group consisting of hydrogen, C₁-C₄ alkyl, C₁-C₄ hydroxyalkyl, and —(C²H₄O)ₓH where x varies from about 1 to about 3. Preferred amides are C₈-C₂₀ ammonia amides, monoethanolamides, diethanolamides, and isopropanolamides.

These and other nonionic surfactants are well known in the art, being described in more detail in Kirk Othmer's Encyclopedia of Chemical Technology, 3rd Ed., Vol. 22, pp. 360-37⁹, “Surfactants and Detersive Systems”, incorporated by reference herein.

ii. Anionic Surfactant

Generally speaking, anionic surfactants useful herein are disclosed in U.S. Pat. No. 4,285,841, Barrat et al, issued Aug. 25, 1981, and in U.S. Pat. No. 3,919,678, Laughlin et al, issued Dec. 30, 1975, both incorporated herein by reference.

Anionic surfactants include, but are not limited to, linear alkylbenzene sulfonate, alpha olefin sulfonate, paraffin sulfonates, alkyl ester sulfonates, alkyl sulfates, alkyl alkoxy sulfate, alkyl sulfonates, alkyl alkoxy carboxylate, alkyl alkoxylated sulfates, sarcosinates, taurinates, and mixtures thereof. More preferably, the anionic surfactants include, but are not limited to, C₁₁-C₁₈ alkyl benzene sulfonates (LAS) and primary, branched-chain and random C₁₀-C₂₀ alkyl sulfates (AS), the C₁₀-C₁₈ secondary (2,3) alkyl sulfates of the formula CH₃(CH₂)ₓ(CHOSO₃³¹M⁺) CH₃ and CH₃ (CH₂)_{y}(CHOSO₃⁻M⁺) CH₂CH₃ where x and (y+1) are integers of at least about 7, preferably at least about 9, and M is a water-solubilizing cation, especially sodium, unsaturated sulfates such as oleyl sulfate, the C₁₀-C₁₈ alkyl alkoxy sulfates (“AE_{X}S”; especially EO 1-7 ethoxy sulfates, such as 1.8 and 1.1), C₁₀-C₁₈ alkyl alkoxy carboxylates (especially the EO 1-11 ethoxycarboxylates), the C₁₀-C₁₈ sulfated glycerol ethers, the C₁₀-C₁₈ sulfated alkyl polyglycosides, and C₁₂-C₁₈ alpha-sulfonated fatty acid esters.

Useful anionic surfactants include the water-soluble salts, particularly the alkali metal, ammonium and alkylolammonium (e.g., monoethanolammonium or triethanolammonium) salts, of organic sulfuric reaction products having in their molecular structure an alkyl group containing from about 10 to about 20 carbon atoms and a sulfonic acid or sulfuric acid ester group. (Included in the term “alkyl” is the alkyl portion of aryl groups.) Examples of this group of synthetic surfactants are the alkyl sulfates, especially those obtained by sulfating the higher alcohols (C₈-C₁₈ carbon atoms) such as those produced by reducing the glycerides of tallow or coconut oil. Especially valuable are linear straight chain alkylbenzene sulfonates in which the average number of carbon atoms in the alkyl group is from about 11 to 13, abbreviated as C₁₁-C₁₃LAS.

Further examples are described in “Surface Active Agents and Detergents” (Vol. I and II by Schwartz, Perry and Berch) and in U.S. Pat. No. 3,929,678, issued Dec. 30, 1975 to Laughlin, et al. at Column 23, line 58 through Column 29, line 23 (herein incorporated by reference).

Highly preferred anionic surfactants include alkyl alkoxylated sulfate surfactants hereof are water soluble salts or acids of the formula RO(A)ₘSO3M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl, trimethyl-ammonium cations and quaternary ammonium cations such as tetramethyl-ammonium and dimethyl piperdinium cations and those derived from alkylamines such as ethylamine, diethylamine, triethylamnine, mixtures thereof, and the like. Exemplary surfactants are C₁₂-C₁₈ alkyl polyethoxylate (1.0) sulfate (C₁₂-C₁₈E(1.0)M), C₁₂-C₁₈ alkyl polyethoxylate (2.25) sulfate (C₁₂-C₁₈E(2.25)M), C₁₂-C₁₈ alkyl polyethoxylate (3.0) sulfate (C₁₂-C₁₈E(3.0)M), and C₁₂-C₁₈ alkyl polyethoxylate (4.0) sulfate (C₁₂-C₁₈E(4.0)M), wherein M is conveniently selected from sodium and potassium.

When included therein, the compositions of the present invention typically comprise from about 0.5%, preferably from about 3%, more preferably from about 5%, most preferably from about 10% to about 90%, preferably to about 50%, more preferably to about 20%, most preferably to about 10% by weight of such anionic surfactants.

iii. Cosurfactants

The compositions of the present invention may further comprise, especially when anionic surfactants are present, a cosurfactant selected from the group of primary or tertiary amines. Suitable primary amines for use herein include amines according to the formula:

R₁NH₂

wherein R₁ is a C₆-C₁₂, preferably C₆-C₁₀ alkyl chain, or R₄X(CH₂)ₙ, wherein X is —O—, —C(O)NH— or —NH—, R₄ is a C₆-C₁₂ alkyl chain n is between 1 to 5, preferably 3. R₁ alkyl chains may be straight or branched and may be interrupted with up to 12, preferably less than 5 ethylene oxide moieties; or

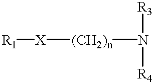

wherein R₁ is a C₆-C₁₂ alkyl group; n is from about 1 to 5, preferably 2 to about 4, more preferably 3. X is a bridging group which is selected from —NH—, —C(O)NH—, —C(O)O—, or —O— or X can be absent; and R₃ and R₄ are individually selected from H, C₁-C₄ alkyl, or (CH₂—CH₂—O(R₅)) wherein R₅ is H or methyl;

Preferred amines according to the formula herein above are n-alkyl amines. Suitable amines for use herein may be selected from 1-hexylamine, 1-octylamine, 1-decylamine and laurylamine. Other preferred primary amines include C8-C10 oxypropylamine, octyloxypropylamine, 2-ethylhexyl-oxypropylamine, lauryl amido propylamine and amido propylamine. The most preferred amines for use in the compositions herein are 1-hexylamine, 1-octylamine, 1 -decylamine, 1 -dodecylamine. Especially desirable are n-dodecyldimethylamine and bishydroxyethylcoconutalkylamine and oleylamine 7 times ethoxylated, lauryl amido propylamine and cocoamido propylamine.

Preferred amines include the following:

R₁—(CH₂)₂—NH₂ (1)

R₁—O—(CH₂)₃—NH₂ (2)

R₁—C(O)—NH—(CH₂)₃—N(CH₃)₂ (3)

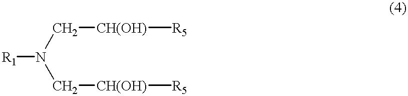

wherein R₁ is a C₆-C₁₂ alkyl group and R₅ is H or CH₃.

In a highly preferred embodiment, the amine is described by the formula:

R₁—C(O)—NH—(CH₂)₃—N(CH₃)₂

wherein R₁ is C₈-C₁₂ alkyl.

Particularly preferred amines include those selected from the group consisting of octyl amine, hexyl amine, decyl amine, dodecyl amine, C₈-C₁₂ bis(hydroxyethyl)amine, C₈-C₁₂ bis(hydroxyisopropyl)amine, and C₈-C₁₂ amido-propyl dimethyl amine, and mixtures.

If utilized the detersive amines comprise from about 0. 1% to about 1 0%, preferably from about 0.5% to about 5%, by weight of the composition.

iv. Quaternary Ammonium Surfactants

Suitable quaternary ammonium surfactants include, but are not limited to, quaternary ammonium surfactants having the formula:

[chemical structure]

wherein R₁ and R₂ are individually selected from the group consisting of C₁-C₄ alkyl, C₁-C₄ hydroxy alkyl, benzyl, and —(C₂H₄O)_{X}H where x has a value from about 2 to about 5; X is an anion; and (1) R₃ and R₄ are each a C₆-C₁₄ alkyl or (2) R₃ is a C₆-C₁₈ alkyl, and R₄ is selected from the group consisting of C₁-C₁₀ alkyl, C₁-C₁₀ hydroxy alkyl, benzyl, and —(C₂H₄O)_{X}H where x has a value from 2 to 5.

Preferred quaternary ammonium surfactants are the chloride, bromide, and methylsulfate salts. Examples of preferred mono-long chain alkyl quaternary ammonium surfactants are those wherein R₁, R₂, and R₄ are each methyl and R₃ is a C₈-C₁₆ alkyl; or wherein R₃ is C₈₋₁₈ alkyl and R₁, R₂, and R₄ are selected from methyl and hydroxy-alkyl moieties. Lauryl trimethyl ammonium chloride, myristyl trimethyl ammonium chloride, palmityl trimethyl ammonium chloride, coconut trimethylammonium chloride, coconut trimethylammonium methylsulfate, coconut dimethyl-monohydroxyethyl-ammonium chloride, coconut dimethyl-monohydroxyethylammonium methylsulfate, steryl dimethyl-monohydroxy-ethylammonium chloride, steryl dimethylmonohydroxy-ethylammonium methylsulfate, di- C₁₂-C₁₄ alkyl dimethyl ammonium chloride, and mixtures thereof are particularly preferred. ADOGEN 412™, a lauryl trimethyl ammonium chloride commercially available from Witco, is also preferred. Even more highly preferred are the lauryl trimethyl ammonium chloride and myristyl trimethyl ammonium chloride.

Alkoxylated quaternary ammonium (AQA) surfactants useful in the present invention are of the general formula:

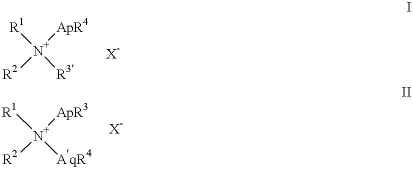

wherein R¹ is an alkyl or alkenyl moiety containing from about 8 to about 18 carbon atoms, preferably 10 to about 16 carbon atoms, most preferably from about 10 to about 14 carbon atoms; R² and R³ are each independently alkyl groups containing from one to about three carbon atoms, preferably methyl; R³ and R⁴ can vary independently and are selected from hydrogen (preferred), methyl and ethyl, X⁻is an anion such as chloride, bromide, methylsulfate, sulfate, or the like, to provide electrical neutrality; A is selected from C₁ -C₄ alkoxy, especially ethoxy (i.e., —CH₂CH₂O—), propoxy, butoxy and mixtures thereof; and for formula I, p is from 2 to about 30, preferably 2 to about 15, most preferably 2 to about 8; and for formula II, p is from 1 to about 30, preferably 1 to about 4 and q is from 1 to about 30, preferably 1 to about 4, and most preferably both p and q are 1.

Other quaternary surfactants include the ammonium surfactants such as alkyldimethylammonium halogenides, and those surfactants having the formula:

[R²(OR³)_{y}][R⁴(OR³)_{y}]₂R⁵N⁺X⁻

wherein R² is an alkyl or alkyl benzyl group having from about 8 to about 18 carbon atoms in the alkyl chain, each R³ is selected from the group consisting of —CH₂CH₂—, —CH₂CH(CH₃)—, —CH₂CH(CH₂OH)—, —CH₂CH₂CH₂—, and mixtures thereof; each R⁴ is selected from the group consisting of C₁-C₄ alkyl, C₁-C₄ hydroxyalkyl, benzyl, ring structures formed by joining the two R⁴ groups, —CH₂CHOHCHOHCOR⁶CHOH—CH₂OH wherein R⁶ is any hexose or hexose polymer having a molecular weight less than about 1000, and hydrogen when y is not 0; R⁵ is the same as R⁴ or is an alkyl chain wherein the total number of carbon atoms of R² plus R⁵ is not more than about 18; each y is from 0 to about 10 and the sum of the y values is from 0 to about 15; and X is any compatible anion.

v. Fatty Acid

Suitable fatty acids that can be incorporated into the compositions of the present invention in addition to surfactants, include, but are not limited to, saturated and/or unsaturated fatty acids obtained from natural sources or synthetically prepared. Examples of fatty acids include capric, lauric, myristic, palmitic, stearic, arachidic, and behenic acid. Other fatty acids include palmitoleic, oleic, linoleic, linolenic, and ricinoleic acid.

vi. Cationic/Amphoteric Surfactants

Non-quaternary, cationic surfactants can also be included in the compositions of the present invention. Cationic surfactants useful herein are described in U.S. Pat. No. 4,228,044, Cambre, issued Oct. 14, 1980.

Amphoteric surfactants can be incorporated into the compositions hereof. These surfactants can be broadly described as aliphatic derivatives of secondary or tertiary amines, or aliphatic derivatives of heterocyclic secondary and tertiary amines in which the aliphatic radical can be straight chain or branched. U.S. Pat. No. 3,929,678 to Laughlin et al., issued Dec. 30, 1975 at column 19, lines 18-35 discloses examples of amphoteric surfactants.

Further examples of suitable amphoteric surfactants are given in “Surface Active Agents and Detergents” (Vol. I and II by Schwartz, Perry and Berch), hereby incorporated by reference.

Preferably the cationic and/or amphoteric surfactants, when present, are present in the composition in an effective amount, more preferably from about 0.1% to about 20%, even more preferably about 0.1% to about 15%, even more preferably still from about 0.5% to about 10%,by weight.

ix. Biodegradably Branched Surfactants

The compositions of the present invention may also include biodegradably branched and/or crystallinity disrupted and/or mid-chain branched surfactants or surfactant mixtures. These surfactants are more fully disclosed in WO98/23712 A published Jun. 4, 1998; WO97/38957 A published Oct. 23, 1997; WO97/38956 A published Oct. 23, 1997; WO97/39091 A published Oct. 23, 1997; WO97/39089 A published Oct. 23, 1997; WO97/39088 A published Oct. 23, 1997; WO97/39087 A1 published Oct. 23, 1997; WO97/38972 A published Oct. 23, 1997; WO 98/23566 A Shell, published Jun. 4, 1998; technical bulletins of Sasol; and the following pending patent applications assigned to Procter & Gamble: U.S. patent application Ser. Nos. 09/170,711 and 09/170,694.

Solvents—The compositions herein may comprise as an optional, but preferable ingredient, a solvent or mixtures thereof. When used, solvents will, advantageously, give an enhanced performance to the compositions of the present invention. Suitable solvents for incorporation in the compositions according to the present invention include propylene glycol derivatives such as n-butoxypropanol or n-butoxypropoxypropanol, water-soluble CARBITOL® solvents or water-soluble CELLOSOLVE® solvents. Water-soluble CARBITOL® solvents are compounds of the 2-(2-alkoxyethoxy)ethanol class wherein the alkoxy group is derived from ethyl, propyl or butyl. A preferred water-soluble carbitol is 2-(2-butoxyethoxy)ethanol also known as butyl carbitol. Water-soluble CELLOSOLVE® solvents are compounds of the 2-alkoxyethoxyethanol class, with 2-butoxyethoxyethanol being preferred. Preferred solvents for use herein are ethanolamines and alcohols. Most preferably, the solvents for use in the present compositions are n-butoxypropoxypropanol, butyl carbitol®, monoethanolamine(MEA), diethanolamine, triethanolamine, benzyl alcohol, methanol, ethanol, isopropyl alcohol and diols such as 2-ethyl-1,3-hexanediol and 2,2,4-trimethyl-1,3-pentanediol and mixture thereof. Water can also be used as a solvent. Preferred solvents are typically utilized in the present compositions at a level of from about 0% to about 30%, preferably from about 0.5% to about 25%, more preferably from about 0.5% to about 20% by weight of the composition.

Other useful solvents for use in the present compositions include a poly(alkylene glycol) alkyl ether, as defined herein after, or mixtures thereof.

Additional useful solvents, especially for use in biocide compositions in accordance with the present invention in the form of paint compositions are xylene and/or methylisobutylketone

Typically, where present the composition may comprise a poly(alkylene glycol) alkyl ether or a mixture thereof at a level of from 0.001% to 10%, preferably from 0.005% to 2%, more preferably from 0.01% to 1%, even more preferably from 0.05% to 0.5% and most preferably from 0.08% to 0.4% by weight of the total composition.

Suitable poly(alkylene glycol) alkyl ethers for use herein are according the following formula:

R¹—O—(CH₂—CHR²O)ₙ—R³

wherein R¹ and R² each independently are hydrogen or a substituted or unsubstituted, saturated or unsaturated, linear or branched hydrocarbon chain having from 1 to 30 carbon atoms or a hydroxy bearing linear or branched hydrocarbon chain having from 1 to 30 carbon atoms, R³ is a substituted or unsubstituted, saturated or unsaturated, linear or branched hydrocarbon chain having from 1 to 30 carbon atoms or a hydroxy bearing linear or branched hydrocarbon chain having from 1 to 30 carbon atoms, n is a number greater than 2, or a mixture thereof.

Preferably R¹ and R² each independently are hydrogen, or a substituted or unsubstituted, linear or branched, alkyl group or alkenyl group having from 1 to 30 carbon atoms, preferably from 1 to 16 carbon atoms, more preferably from 1 to 8 and most preferably from 1 to 4, or a hydroxy bearing linear or branched alkyl or alkenyl group having from 1 to 30 carbon atoms, more preferably from 1 to 16, even more preferably from 1 to 4, and most preferably R¹ and R² are methyl or hydrogen.

Preferably R³ is a substituted or unsubstituted, linear or branched, alkyl group or alkenyl group having from 1 to 30 carbon atoms, preferably from 1 to 16 carbon atoms, more preferably from 1 to 8 and most preferably from 1 to 4, or a substituted or unsubstituted, saturated or unsaturated, linear or branched aryl group having up to 30 carbon atoms, preferably from 3 to 16 and more preferably from 4 to 8 carbon atoms, or a hydroxy bearing linear or branched alkyl or alkenyl group having from 1 to 30 carbon atoms, more preferably from 1 to 16 even more preferably from 1 to 8, and most preferably R³ is butyl.

Preferably n is a number of at least 3, preferably from 3 to 2300, more preferably 3 to 100, more preferably from 3 to 20 and most preferably from 3 to 10.

The poly(alkylene glycol) alkyl ethers for use herein preferably have an average molecular weight from 164 to 100,000, more preferably from 180 to 10,000 and most preferably from 200 to 1,000.

Suitable poly(alkylene glycol) alkyl ethers for use herein include poly(propylene glycol) mono butyl ether, poly(ethylene glycol-co-propylene glycol) mono butyl ether, poly(ethylene glycol) dimethyl ether, poly(ethylene glycol-co-propylene glycol) dimethyl ether, poly(ethylene glycol) stearate or mixtures thereof. Poly(propylene glycol) mono butyl ether (average molecular weight 340) is commercially available from Aldrich or from Union Carbide under Ucon-1b 65®.

Other useful solvents for compositions of the present invention include those disclosed in U.S. Pat. Nos. 5,540,865; 5,435,935; and 5,362,422; which are hereby incorporated by reference.

A preferred type of non-aqueous, low-polarity solvent for use in the compositions herein comprises the non-vicinal C₄-C₈ branched or straight chain alkylene glycols. Materials of this type include hexylene glycol (4-methyl-2,4-pentanediol), 1,6-hexanediol, 1,3-butylene glycol and 1,4-butylene glycol. Hexylene glycol is the most preferred.

Another preferred type of non-aqueous, low-polarity solvent for use herein comprises the mono-, di-, tri-, or tetra- C₂-C₃ alkylene glycol mono C₂-C₆ alkyl ethers. The specific examples of such compounds include diethylene glycol monobutyl ether, tetraethylene glycol monobutyl ether, dipropolyene glycol monoethyl ether, and dipropylene glycol monobutyl ether. Diethylene glycol monobutyl ether, dipropylene glycol monobutyl ether and butoxy-propoxy-propanol (BPP) are especially preferred. Compounds of the type have been commercially marketed under the trade names Dowanol, Carbitol, and Cellosolve.

Another preferred type of non-aqueous, low-polarity organic solvent useful herein comprises the lower molecular weight polyethylene glycols (PEGs). Such materials are those having molecular weights of at least about 150. PEGs of molecular weight ranging from about 200 to 600 are most preferred.

Other Antimicrobial Actives—The compositions of the present invention may optionally comprise one or more other antimicrobial agents. Suitable other antimicrobial agents include, but are not limited to, alkylbenzyldimethylammonium chloride, dialkyldimethylammonium chloride, isopropanol, propylene glycol, hypochlorite, organic acids such as citric acid, bases such as hydroxide, hydrogen peroxide, triclosan and biguanides.

A nonlimiting list of suitable other antimicrobial agents for use in the compositions of the present invention follows: 3′,4,4′-trichloro-2-hydroxydiphenyl ether; 4,4′-dichloro-2-hydrocydiphenyl ether; 4-chloro-4′-iodo-2-hydroxydiphenyl ether; 4-chloro-4′-fluoro-2-hydroxydiphenyl ether; 4-chloro-4′-bromo-2-hydroxydiphenyl ether; 3,5′,4-tribromo-2-hydroxydiphenyl ether; 4-bromo4′-chloro-2-hydroxydiphenyl ether; 4-bromo-2′,4-dichloro-2-hydroxydiphenyl ether; 4,4′-dibromo-2-hydroxydiphenyl ether; 4,2′-4′, 4-dichloro-2-hydroxydiphenyl ether; 4,4′,5′-trichloro-2-hydroxydiphenyl ether; 2,6-dimethyl-4-hydroxychlorobenzene; 3,4,4′-trichlorocarbanilide; 3-trifluoromethyl4,4′-dichlorocarbanilide; 2,2′-dihydroxy-3,3′,5,5′,6,6′-hexachlorodiphenylmethane; 2,2′-dihydroxy-3,3′,5,5′-tetrachlorodiphenylmethane; 2,2′-dihydroxy-3,3′-dibromo-5,5′-dichlorodiphenylmethane; 1-hydroxy-4-methyl-6-(2,4,4′-trimethylpentyl)-2-(1H)-pyridinone; Benzalkonium chloride; Benzethonium chloride; Carbolic acid; 1,6-di(4′-chlorophenyl-diguanido)hexane); Cresylic acid; 5-amino-1,3-bis(2-ethylhexyl)-5-methylhexahydropyrimidine); lodophors; Methylbenzethonium chloride; Povidone-lodine; Tetramethylthiuran disulfide; Tribrominated salicylanilide; 2-bromo-2-nitropropane-1,3-diol; cis Isomer of 1-(3-chloroallyl)-3,5,7-triaza-1-azoniaadamantane-chloride; 3-Iodo-2-propynyl butyl carbamate; Dimethyloldimethylhydantoin; 3-iodo-2-propynyl butyl carbamate+Hydantoin; Formaldehyde; Diazolidinyl Urea; Imidazolidinyl Urea; Glutaraldehyde; Kathon CG; Methyl paraben; Ethyl paraben; Propyl paraben; Butyl paraben; O-Benzyl-p-chlorophenol; O-phenylphenol; Sodium Phenylphenol; Fentichlor; 2-Phenoxyethanol; Salicylic acid; Halogenated salicylic acids; Sorbic acid; Amphoteric surfactants; Cationic surfactants; Amine oxide; Halogenated phenols; 2-pyridinethiol-1-oxide; 5,7-diiodo-8-hydroxyquinoline; 1-(3-Chloroallyl)-3,5,7-triaza-1-azoniaadamantane chloride; N-chloro-para-toluenesulfonamide; Diiodomethyl p-tolyl sulfone; Tetrachloro-4-(methylsulfonyl)pyridine; pentachlorophenol, sodium salt; Cyclopentyl p-chlorophenol; Sodium 2,4,5-trichlorophenate; Tetrachlorophenol; Sodium tetrachlorophenate; Dowicide 31; Pentachlorophenol ; 2,4,6-Trichloro-2-hydroxybenzene; 2-Chloro-4-phenylphenol; 2,4,5-Trichlorophenol; 2,2-Dibromo-3-nitrilopropionamide; and salts of the aforementioned antimicrobials

A wide range of quaternary compounds can also be used as antimicrobial actives. Non-limiting examples of useful quaternary compounds include: (1) benzalkonium chlorides and/or substituted benzalkonium chlorides such as commercially available Barquat® (available from Lonza), Maquat® (available from Mason), Variquat® (available from Witco/Sherex), and Hyamine® (available from Lonza); (2) di(C₆-C₁₄)alkyl di short chain (C₁₋₄ alkyl and/or hydroxyalkl) quaternary such as Bardac® products of Lonza, (3) N-(3-chloroallyl) hexaminium chlorides such as Dowicide® and Dowicil® available from Dow; (4) benzethonium chloride such as Hyamine® 1622 from Rohm & Haas; (5) methylbenzethonium chloride represented by Hyamine® 10X supplied by Rohm & Haas, (6) cetylpyridinium chloride such as Cepacol chloride available from of Merrell Labs. Examples of the preferred dialkyl quaternary compounds are di(C₈-C₁₂)dialkyl dimethyl ammonium chloride, such as didecyldimethylammonium chloride (Bardac 22), and dioctyldimethylammonium chloride (Bardac 2050). Typical concentrations for biocidal effectiveness of these quaternary compounds range from about 0.001% to about 0.8%, preferably from about 0.005% to about 0.3%, more preferably from about 0.01% to about 0.2%, and even more preferably from about 0.03% to about 0.1%, by weight of the usage composition. The corresponding concentrations for the concentrated compositions are from about 0.003% to about 2%, preferably from about 0.006% to about 1.2%, and more preferably from about 0. 1% to about 0.8% by weight of the concentrated compositions.

Nonlimiting examples of suitable organic acids that can be used in the compositions of the present invention include citric, malic, succinic, and benzoic, which, when used in suitable concentrations, as further described herein, are highly efficacious against microbes, such as Salmonella choleraesuis and Staphylococcus aureus. When used in the presence of a surfactant, preferably a nonionic surfactant such as alcohol ethoxylates (for example, ALFONIC® 810-6 Ethoxylated available from Vista Chemical Company in Houston, Tex.), these acids were found to have effective residual antimicrobial activity against a variety of microbes, including gram negative (−) bacteria, such as Salmonella choleraesuis, and gram positive (+) bacteria, such as Staphylococcus aureus. In general, the water soluble carboxylic acids useful in accordance with the invention have the following structure:

R—COOH

wherein R may be represented by: lower alkyl; substituted lower alkyl; hydroxy lower alkyl (e.g. HOCH₂—); carboxy lower alkyl (e.g. HOOC—CH₂—CH₂—); carboxy, hydroxy lower alkyl (e.g., HOOCCH₂ CHOH—); carboxy, halo lower alkyl (e.g. HOOCCH₂CHBr—); carboxy, dihydroxy lower alkyl (e.g. HOOC—CHOH—CHOH—); dicarboxy, hydroxy lower alkyl (e.g. HOOC—CH₂C—C(OH)(COOH) H₂—); lower alkenyl, carboxy lower alkenyl (e.g. HOOCCH═CH—); dicarboxy lower alkenyl (e.g. HOOC—CH₂C(COOH)═CH—); phenyl (C₆ H₅—); substituted phenyl (e.g. hydroxy phenyl HO—C₆ H₄—). Other acid examples include hydroxy lower alkyl e.g. lactic; carboxy, hydroxy lower alkyl, e.g. 2-methyl malic; carboxy, halo lower alkyl, e.g. 2-chloro-3-methyl succinic; carboxy, dihydroxy lower alkyl, e.g. 2-methyl tartaric; dicarboxy, hydroxy lower alkyl, e.g. 2-methyl citric acid; and carboxy lower alkenyl, e.g. fumaric. The above definitions are used in an illustrative but not a limiting sense. The term “lower” as used herein refers to an acid wherein “R” contains one to six carbon atoms. The term “substituted” indicates that one or more hydrogen atoms are substituted by halogen atoms (F, Cl, Br, I) hydroxyl groups, amino groups, thiol groups, nitro groups, cyano groups, and the like. Examples of preferred antimicrobial organic acids include, but are not limited to, citric acid, lactic acid, malic acid, salicylic acid, acetic acid, and mixtures thereof.

In a preferred embodiment, the compositions comprise organic acid at a level of from about 0.5% to about 20%, more preferably from about 1% to about 10%, and still more preferably from about 1.5% to about 7.5% by weight of the antimicrobial composition. Citric acid is a highly preferred organic acid having antimicrobial action. Citric acid is preferred because it is a natural acid and is relatively safe for use on household surfaces, especially surfaces used for food preparation such as countertops in kitchens and dining rooms. In addition, when citric acid is allowed to remain on a surface, it tends to provide a glossy or shiny film on the surface which can be aesthetically satisfying to consumers and provide a visual signal to consumers that the surface has residual antimicrobial protection. Also, the glossy film allows the consumer to identify areas on the hard surface which were inadvertently missed in treating the surface and allows the consumer to verify that an entire area has been treated.

Resins/Binding Agents—One or more resins may be incorporated into the biocide compositions of the present invention, especially if the biocide composition is a paint. Preferred resins are selected from the group consisting of vinyl, alkyd, epoxy, acrylic, polyurethane and polyester resins, and combinations thereof.

Binding Agents—Suitable binding agents that can be used in the compositions of the present invention, especially in marine antifouling coatings include, but are not limited to, polvinyl chloride in a solvent based system, chlorinated rubber in a solvent based system, acrylic resins in solvent based or aqueous based systems, vinyl chloride-vinyl acetate copolymer systems as aqueous dispersions or solvent based systems, butadiene-styrene rubbers, butadiene-acrylonitrile rubbers, butadiene-styrene-acrylonitrile rubbers, drying oils such as linseed oil, asphalt, epoxies, siloxanes and the like.

Swelling Agents—Illustrative swelling agents which may be used in the compositions of the present invention are naturally-occurring or synthetic clays, such as kaolin, montomorillonite bentonite), clay mica (muscovite), and chlorite (hectonite), and the like. In addition to clays, other swelling agents, including natural or synthetic polymers, such as that commercially available as POLYMERGEL, have been found to be useful in the compositions of the present invention to provide the desired “sloughing off” effect.

Thickening Agents—Illustrative thickening agents which may be used in the compositions of the present invention include cellulose derivatives, for example methyl, hydroxyethyl, hydroxypropyl and carboxymethyl cellulose, poly(vinyl alcohol), poly (vinylpyrolidone), poly(ethylene-glycol), salts of poly(acrylic acid) and salts of acrylic acid/acrylamide copolymers.

Wetting/Dispersing Agents—Suitable wetting and dispersing agents which may be used in the compositions of the present invention include sodium polyphosphate, aryl or alkyl phosphates, salts of low-molecular-weight poly(acrylic acid), salts of poly(ethane-sulfonic acid), salts of poly (vinyl-phosphonic acid), salts of poly(maleic acid) and salts of copolymers of maleic acid with ethylene, 1-olefins with 3 to 18 carbon atoms and/or styrene.

Other Adjunct Ingredients—Other adjunct ingredients that may be added to the biocide compositions of the present invention include, but are not limited to pigments, especially for biocide compositions of the present invention when used as paints, and other adjunct ingredients known to those of ordinary skill in the art that are typically present in the various types of compositions described herein.

BACTERIA

The substrates/articles used in accordance with the present invention may contain bacteria. The bacteria may be any bacteria known to those skilled in the art. The bacteria may be gram negative or gram positive. Preferably, the bacteria is selected from the group consisting of: Staphylococcus aureus, Staphylococcus haemolyticus, Staphylococcus capitis, Klebsiella pneumoniae, Proteus mirabilis, Serratia marcescens, Staphylococcus epidermis, Salmonella typhimurium, Shigella dysenteriae, Streptococcus faecalis, Streptococcus pyogenes, Corynebacterium xerosis, Micrococcus varians, Micrococcus luteus, Peptostreptococcus anaerobius, Propionibacterium acnes, Propionibacterium avidum, Propionibacterium granulosum, Escherichia coli, Salmonella choleraesius, Listeria monocytogenes, Enterococcus hirae and mixtures thereof, most preferably the bacteria is selected from the group consisting of: Escherichia coli, Salmonella choleraesius and mixtures thereof.

METHODS OF THE PRESENT INVENTION

A method for microorganism-reducing a microorganism-containing substrate/article, such as those substrates/articles disclosed hereinbefore, comprising contacting the substrate/article with a microorganism-reducing system and/or antibacterial composition in accordance with the present invention, such that bacteria on or in a microorganism-containing substrate is reduced (i.e., rendered inactive, killed, etc.).

The contacting step of the methods of the present invention can be any suitable step known to those skilled in the art. For example, dipping, spraying, coating, soaking, brushing, etc.

MICROORGANISM-REDUCED SUBSTRATE/ARTICLE

A microorganism-reduced substrate/article results the methods of the present invention.

PRODUCT/INSTRUCTIONS OF USE

This invention also may encompass the inclusion of instructions on the use of the microorganism-reducing systems and/or antibacterial compositions described herein with the packages containing the microorganism-reducing systems and/or antibacterial compositions or with other forms of advertising associated with the sale or use of the microorganism-reducing systems and/or antibacterial compositions. The instructions may be included in any manner typically used by consumer product manufacturing or supply companies. Examples include providing instructions on a label attached to the container holding the system and/or composition; on a sheet either attached to the container or accompanying it when purchased; or in advertisements, demonstrations, and/or other written or oral instructions which may be connected to the purchase or use of the microorganism-reducing systems and/or antibacterial compositions.

Specifically the instructions will include a description of the use of the microorganism-reducingsystem and/or antibacterial composition. The instructions, for instance, may additionally include information relating to the recommended amount of antibacterial composition to apply to the microorganism-containing substrate/article, if soaking or rubbing is appropriate to the substrate/article; the recommended amount of water, if any, to apply to the substrate/article before and after treatment; other recommended treatment.

The microorganism-reducingsystem and/or antibacterial composition may be incorporated into a product, the product may be a kit comprising the microorganism-reducingsystem and/or antibacterial composition. Accordingly, a product comprising a microorganism-reducingsystem and/or antibacterial composition of the present invention, the product further including instructions for using the microorganism-reducingsystem and/or antibacterial composition to reduce bacteria kill and/or on and/or in a microorganism-containing substrate/article.

Nonlimiting examples of suitable products and/or compositions and/or microorganism-reducing systems in which the biocides may be used may be in any product form known to those of ordinary skill in the art, such as granules, powder, paste, foam, tablets, dimple tablets, bars, sprays, liquids, dryer-added forms, impregnated sheets, coated sheets, gels, etc.

While particular embodiments of the subject invention have been described, it will be obvious to those skilled in the art that various changes and modifications of the subject invention can be made without departing from the spirit and scope of the invention. It is intended to cover, in the appended claims, all such modifications that are within the scope of the invention.

Having described the invention in detail with reference to preferred embodiments and the examples, it will be clear to those skilled in the art that various changes and modifications may be made without departing from the scope of the invention and the invention is not to be considered limited to what is described in the specification.

What is claimed is:

1. A method for controlling or inhibiting the growth of fungi, bacteria, algae, marine fouling organisms, plants, and insects comprising introducing a biocide composition comprising:
A) a biocide compound of formula I, 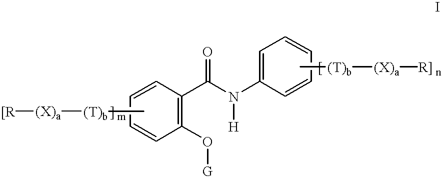
wherein m is an integer from 0 to 2; n is an integer from 0 to 2; the sum of m+n is greater than zero; a is 0 or 1; b is 0 or 1; X, when present, is selected from O, S, and NR¹, where R¹ is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl; T, when present, is selected from C═O and SO₂; when T is SO₂, X may not be S; R is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl provided that the ratio of halogen atoms to the carbon atoms in said R is less than 3; when a and b are both 0 for a radical, R for that radical may be further selected from the group consisting of F, Cl, Br, I, CN, R₂N→O, NO₂; when all a and b are 0, at least one R must be non-H; no more than one R may be halogen; G is H, a suitable charge balancing counterion (Mⁿ⁺)_{1/n}, or a cleaveable group selected from the group consisting of Si((O)ₚR²)₃, where p is independently 0 or 1; C(O)_{q}((O)ₚR²)ᵣ, wherein p is independently 0 or 1 and when q is 1, r is 1, and when q is 0, r is 3; R² is independently selected from the group consisting of C₁-C₁₆ linear or branched, substituted or unsubstituted alkyl, alkenyl, alkynyl, cycloalkyl, cycloalkenyl, alkaryl, aralkyl, and aryl, and mixtures thereof; and
B) at least 1 wt % of a surfactant system, wherein the ratio of the weight of the surfactant system divided by the weight of said compound I is greater than or equal to 1.0;
to a locus to be protected.

2. The method according to claim 1 wherein the compound is selected from the group consisting of 4-chlorosalicylanilide, 5-chlorosalicylanilide and mixtures thereof.

3. The method according to claim 2 wherein the compound is 5-chlorosalicylanilide.

4. The method of claim 1 wherein the locus to be protected is selected from: cooling towers; air washers; mineral slurries; pulp and paper processing fluids; paper coatings; adhesives; caulks; mastics; sealants; agriculture adjuvant preservation; construction products; cosmetics and toiletries; shampoos; disinfectants and antiseptics; formulated industrial and consumer products; soaps; laundry rinse waters; leather and leather products; wood; plastics; lubricants; hydraulic fluids; medical devices; metalworking fluids; emulsions and dispersions; paints; varnishes; latexes; odor control fluids; coatings; petroleum processing fluids; fuel; oil field fluids; photographic chemicals; printing fluids; sanitizers; detergents; textiles; textile products; marine structures; plants; soil; and seeds.

5. The method of claim 4 wherein the marine structure is selected from the group consisting of boats, oil platforms, piers, pilings, docks, elastomeric rubbers, and fish nets.

6. A method for controlling or inhibiting the growth of fungi, bacteria, algae, marine fouling organisms, plants, and insects comprising introducing a biocide composition comprising:
A) a biocide compound of formula I, 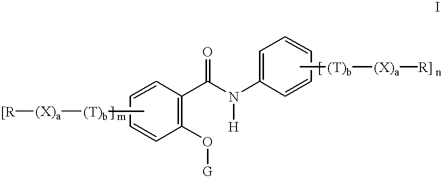
wherein m is an integer from 0 to 2; n is an integer from 0 to 2; the sum of m+n is greater than zero; a is 0 or 1; b is 0 or 1; X, when present, is selected from 0, S, and NR¹, where R¹ is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl; T, when present, is selected from C═O and SO₂; when T is SO₂, X may not be S; R is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl provided that the ratio of halogen atoms to the carbon atoms in said R is less than 3; when a and b are both 0 for a radical, R for that radical may be further selected from the group consisting of F, Cl, Br, I, CN, R₂N→O, NO₂; when all a and b are 0, at least one R must be non-H; no more than one R may be halogen; G is H, a suitable charge balancing counterion (Mⁿ⁺)_{1/n}, or a cleaveable group selected from the group consisting of Si((O)ₚR²)₃, where p is independently 0 or 1; C(O)q((O)ₚR²)ᵣ, wherein p is independently 0 or 1 and when q is 1, r is 1, and when q is 0, r is 3; R² is independently selected from the group consisting of C₁ -C₁₆ linear or branched, substituted or unsubstituted alkyl, alkenyl, alkynyl, cycloalkyl, cycloalkenyl, alkaryl, aralkyl, and aryl, and mixtures thereof; and
B) from 0.5% to 90% of a solvent whose Hildebrand solubility parameter d_{S} (cal/cm³)^{½} meets the following criterion: 5<d_{S}<20;
to a locus to be protected, further provided that a 10 wt % aqueous solution of this composition has a pH≧(pKa−1) where pKa is the calculated pKa of the phenol or thiophenol of formula I, or when G is not H, the pKa of the phenol or thiophenol of formula I that results from replacing G with H.

7. The method according to claim 6 wherein the compound is selected from the group consisting of 4-chlorosalicylanilide, 5-chlorosalicylanilide and mixtures thereof.

8. The method according to claim 7 wherein the compound is 5-chlorosalicylanilide.

9. The method of claim 6 wherein the locus to be protected is selected from: cooling towers; air washers; mineral slurries; pulp and paper processing fluids; paper coatings; adhesives; caulks; mastics; sealants; agriculture adjuvant preservation; construction products; cosmetics and toiletries; shampoos; disinfectants and antiseptics; formulated industrial and consumer products; soaps; laundry rinse waters; leather and leather products; wood; plastics; lubricants; hydraulic fluids; medical devices; metalworking fluids; emulsions and dispersions; paints; varnishes; latexes; odor control fluids; coatings; petroleum processing fluids; fuel; oil field fluids; photographic chemicals; printing fluids; sanitizers; detergents; textiles; textile products; marine structures; plants; soil; and seeds.

10. The method of claim 9 wherein the marine structure is selected from the group consisting of boats, oil platforms, piers, pilings, docks, elastomeric rubbers, and fish nets.

11. A microorganism-reducing system comprising a biocide compound of formula I, 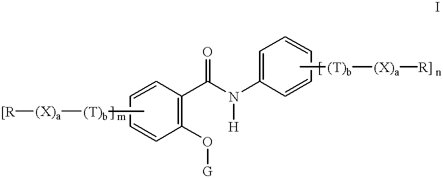
wherein m is an integer from 0 to 2; n is an integer from 0 to 2; the sum of m+n is greater than zero; a is 0 or 1; b is 0 or 1; X, when present, is selected from O, S, and NR¹, where R¹ is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl; T, when present, is selected from C═O and SO₂; when T is SO₂, X may not be S; R is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl provided that the ratio of halogen atoms to the carbon atoms in said R is less than 3; when a and b are both 0 for a radical, R for that radical may be further selected from the group consisting of F, Cl, Br, I, CN, R₂N→O, NO₂; when all a and b are 0, at least one R must be non-H; no more than one R may be halogen; G is H, a suitable charge balancing counterion (Mⁿ⁺)_{1/n}, or a cleaveable group selected from the group consisting of Si((O)ₚR²)₃, where p is independently 0 or 1; C(O)_{q}((O)ₚR²)ᵣ, wherein p is independently 0 or 1 and when q is 1, r is 1, and when q is 0, r is 3; R² is independently selected from the group consisting of C₁-C₁₆ linear or branched, substituted or unsubstituted alkyl, alkenyl, alkynyl, cycloalkyl, cycloalkenyl, alkaryl, aralkyl, and aryl, and mixtures thereof;
wherein the microorganism-reducingsystem reduces bacteria on a substrate, and wherein the substrate is selected from the group consisting of: cooling towers; air washers; paper coatings; adhesives; caulks; mastics; sealants; construction products; disinfectants and antiseptics; leather and leather products; wood; plastics; medical devices; latexes; coatings; photographic chemicals; and textiles.

12. The system according to claim 11 wherein the compound is selected from the group consisting of 4-chlorosalicylanilide, 5-chlorosalicylanilide and mixtures thereof.

13. The system according to claim 12 wherein the compound is 5-chlorosalicylanilide.

14. A process for protecting industrial materials and water systems from attack by harmful organisms or for controlling the latter on or in industrial materials and water systems, which comprises incorporating in or applying to the said materials or systems a biocide compound of formula I 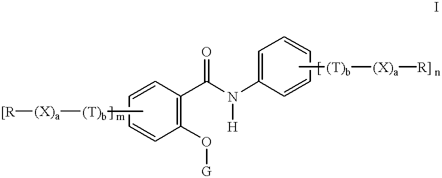
wherein m is an integer from 0 to 2; n is an integer from 0 to 2; the sum of m+n is greater than zero; a is 0 or 1; b is 0 or 1; X, when present, is selected from O, S, and NR¹, where R¹ is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl; T, when present, is selected from C═O and SO₂; when T is SO₂, X may not be S; R is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl provided that the ratio of halogen atoms to the carbon atoms in said R is less than 3; when a and b are both 0 for a radical, R for that radical may be further selected from the group consisting of F, Cl, Br, I, CN, R₂N→O, NO₂; when all a and b are 0, at least one R must be non-H; no more than one R may be halogen; G is H, a suitable charge balancing counterion (Mⁿ⁺)_{1/n}, or a cleaveable group selected from the group consisting of Si((O)ₚR²)₃, where p is independently 0 or 1; C(O)_{q}((O)ₚR²)ᵣ, wherein p is independently 0 or 1 and when q is 1, r is 1, and when q is 0, r is 3; R² is independently selected from the group consisting of C₁-C₁₆ linear or branched, substituted or unsubstituted alkyl, alkenyl, alkynyl, cycloalkyl, cycloalkenyl, alkaryl, aralkyl, and aryl, and mixtures thereof.

15. The process according to claim 14 wherein the compound is selected from the group consisting of 4-chlorosalicylanilide, 5-chlorosalicylanilide and mixtures thereof.

16. The process according to claim 15 wherein the compound is 5-chlorosalicylanilide.

17. A paint or paint base composition characterized by enhanced biocidal efficacy and gelation resistance wherein the paint or paint base contains a biocide compound of formula I 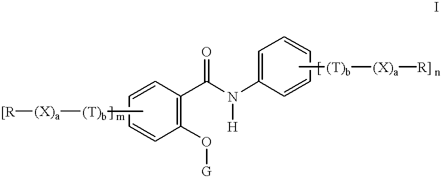
wherein m is an integer from 0 to 2; n is an integer from 0 to 2; the sum of m+n is greater than zero; a is 0 or 1; b is 0 or 1; X, when present, is selected from O, S, and NR¹ where R¹ is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl; T, when present, is selected from C═O and SO₂; when T is SO₂, X may not be S; R is independently selected from the group consisting of H, C₁-C₁₆ linear or branched, substituted or unsubstituted alkyl, alkenyl, alkynyl, cycloalkyl, cycloalkenyl, alkaryl, aralkyl, and aryl provided that the ratio of halogen atoms to the carbon atoms in said R is less than 3; when a and b are both 0 for a radical, R for that radical may be further selected from the group consisting of F, Cl, Br, I, CN, R₂N→O, NO₂; when all a and b are 0, at least one R must be non-H; no more than one R may be halogen; G is H, a suitable charge balancing counterion (Mⁿ⁺)_{1/n}, or a cleaveable group selected from the group consisting of Si((O)ₚR² )₃, where p is independently 0 or 1; C(O)_{q}((O)ₚR² )ᵣ, wherein p is independently 0 or 1 and when q is 1, r is 1, and when q is 0, r is 3; R² is independently selected from the group consisting of C₁-C₁₆ linear or branched, substituted or unsubstituted alkyl, alkenyl, alkynyl, cycloalkyl, cycloalkenyl, alkaryl, aralkyl, and aryl, and mixtures thereof.

18. The paint or paint base composition of claim 17 further comprising a resin, an organic solvent, and a pigment.
